(19) United States
(12) Patent Application Publication
(10) Pub. No.: US 2022/0008934 A1
(43) Pub. Date: Jan. 13, 2022

(54) JIG CONCENTRATOR

(71) Applicants: Richard SNOBY, Dahlonega, GA (US); Andrew SNOBY, Dahlonega, GA (US)

(72) Inventors: Richard SNOBY, Dahlonega, GA (US); Andrew SNOBY, Dahlonega, GA (US)

(21) Appl. No.: 17/486,718

(22) Filed: Sep. 27, 2021

Related U.S. Application Data
(63) Continuation of application No. PCT/US2020/025538, filed on Mar. 27, 2020.
(60) Provisional application No. 62/824,435, filed on Mar. 27, 2019.

(51) Int. Cl. B03B 5/22; B03B 5/24

(52) U.S. Cl. CPC B03B 5/22; B03B 5/24

(57) ABSTRACT

A jig concentrator apparatus has a jigging bed having a plurality of holes, a flow control valve associated with the jigging bed to control a flow of fluid, a pulsation valve connected to the flow control valve for controlling a pulsation of water or media, wherein the valve is housed under the bed, a water or fluid inlet attached to the water pulsation valve for input of water in the apparatus, and a pressured air buffer mounted on the water inlet to buffer and store air in the jig concentrator.

### CROSS REFERENCE TO RELATED APPLICATIONS

This application claims the benefit of U.S. Provisional Application No. 62/824,435, entitled “Jig Concentrator” filed Mar. 27, 2019, PCT Application No. PCT/US2020/025538, entitled “Jig Concentrator” fled Mar. 27, 2020, the contents of which are incorporated herein by reference in their entirety and for all purposes.

### TECHNICAL FIELD

This application relates to jigs. This application relates to jigs which separate materials in a feed mixture on the basis of differing specific gravities.

### BACKGROUND

Jigging and wet jigging has been used for hundreds of years to separate materials. Typical jigs use a jig tank which is open at its top and bottom ends. The material being delivered to the jig may be sized to prevent oversized or undersized particles from entering the jig tank by perforated screens, and can be caused to flow down a portion of the chute to be discharged from the jig. In the upper portion of the jig tank a material support device, such as perforated screen plate or other supports with a plurality of holes, can support the material to be jigged and allow fluid to be pulsed through the material support device. The material (e.g., ore) containing light and heavy particles (e.g., by specific gravity) are transported in the jig from feed end to discharge end by water pulsation or pulsation and additional material being delivered to the jig.

The material support may have a grate on top of it which acts as a containment grid for ragging material. Water pulsation or pulsations within the jig lift the ragging up and off the screen and create a dilation of the bed of material above the screen. This puts particles in the bed in a state of suspension. Heavier particles within the bed progress downwardly into the ragging until they are finally able to pass through the screen. The particles settle within the tank until they are able to exit at the bottom through a valve.

A jig is an apparatus that accomplishes two primary functions. It stratifies material according to density and then makes a separation. The act of jigging to stratify particles according to their density generally occurs through four (4) fundamental actions or phases. First, the differential acceleration phase occurs from the initial upward pulsation of the jigging fluid and the smaller, lighter particles are accelerated faster and higher than coarser, more dense particles. Second, the free settling velocity phase allows the larger, higher density particles to begin falling sooner and faster. Hindered settling is the third phase and occurs when the jigging bed of material becomes smaller and the particles bump into each other and prevents larger, low-density particles from falling through the stratified bed of particles. The final phase is consolidated trickling in which the very small, high-density particles are drawn to the lower levels of the stratified bed during the suction stroke. The light and heavy particles may be separated by using their abilities to penetrate an oscillating fluid bed supported on a screen. Separation of light and heavy articles may also be achieved by measuring the interface between a selected layer of light and heavy particles and withdraw heavy particles from the lower layer of the jigged bed of material with a mechanical device such as a valve, star gate, vibrating feeder and other devices known to people familiar with the art.

People familiar with the art of jigging will recognize that a pulsating current of fluid, including water may be generated by a plunger, mechanical lever, air injection, flexible diaphragm etc. to dilate and collapse a mixture of particles. Each system has benefits and limitations. Mechanical systems wear and ultimately fail. In systems that use air to set the water into motion, there is always the need for additional space to contain the air by achieving optimized stratification of particles according to specific density. By optimizing the stratification of particles according to their respective densities, it allows the second primary function of a jig, separation, to be accomplished more efficiently, it allows the second primary function of a jig, separation, to be accomplished more efficiently.

Accordingly, there is always a need for an improved jig or jig concentrator. This application is directed to these needs among others.

### SUMMARY

This application discloses a jig or a jig concentrator for separating heavy and light particles from materials having varying specific gravity. In one example, the jig can separate heavies and lights from ores and minerals from ores. The jig can be used on material that traditionally is separated with a jig or density separator.

One embodiment includes a jig or jig concentrator apparatus having a bed or jigging bed for stratifying and separating heavy and light particles, which can be effective over a wider distance than current technology and thus offer increased capacity. The jig bed can support the material and can allow the water to flow through the holes in the jig bed, which creates pulsation (e.g., pushing and driving) and suction strokes. The jig can be wider because the water can be introduced directly under the jigging bed. The jig can have a flow control valve associated with the jigging bed to control a flow of fluid. The flow control valve can restrict the flow per unit of time (the complete stroke cycle) to establish the amplitude of the jigging stroke. The jig can have a water pulsation valve connected to the flow control valve for controlling a pulsation of water and for determining the frequency of the jigging stroke. The jig can also have a water inlet attached to the water pulsation valve for input of water in the apparatus. A pressured air buffer or expansion chamber can be mounted on the water inlet to buffer and store air. The air buffer can be used to avoid water pressure or hammering to the pump supplying water to the jig.

One embodiment can provide a jig concentrator that achieves optimized layering of the light and heavy particles with lower cost and allows jigs to be wider while maintaining optimum stratification of light and heavy particles.

According to an embodiment of this application, a jig concentrator has a jigging bed installed in the apparatus for supporting heavy and light particles, through which a fluid, usually water, may flow, a flow control valve associated with the jigging bed to control a flow of fluid, a water pulsation valve connected to the flow control valve for controlling a pulsation of water, a water inlet attached to the water pulsation valve for input of water in the apparatus and a pressured air buffer mounted on the water inlet to buffer and store air in the apparatus.

Another specific embodiment is a jig concentrator having a jigging bed having one or more holes, a flow control valve associated with the jigging bed to control a flow of fluid, a pulsation valve connected to the flow control valve for controlling a pulsation of water or media, wherein the valve is housed under the bed, a water inlet attached to the water pulsation valve for input of water in the apparatus; and a pressured air buffer mounted on the water inlet to buffer and store air in the apparatus. There can be a plurality of hutches forms the longer jigging bed for storing of the fluid and sorting the material. The pulsation valve can be housed under the fluid inlet to independently control by-pass of the fluid. The jig can have pipes, under the jig bed, with holes to create even distribution of fluid through jigging bed in the jig concentrator. There can be a punched screen plate connected to the jigging bed for supporting a ragging material. Further, a plurality of delivery pipes is attached to the hutch for input of the fluid in the jig. The concentrator can have multiple chambers that are connected to the hutch for collecting any heavy and light particles. A plurality of slots associated with delivery pipes for the even delivery of jigging fluid can optimize the stratification of the material the in layers based on density.

Another embodiment includes a method of sizing and separating particles of a generally low-density material, using a jig concentrator comprising a stand, a frame, a jigging bed in the frame on the stand, wherein the jigging bed supports allows the water to flow through the holes in the jig bed to create pulsation and suction stroke motion, a flow control valve associated with the jigging bed to control a flow of fluid, wherein the flow control valve restricts the flow per unit of time to establish the amplitude of the jigging stroke; a water pulsation valve connected to the flow control valve for controlling a pulsation of water and for determining the frequency of the jigging stroke, and a water inlet attached to the water pulsation valve for input of water in the apparatus; and a pressured air buffer mounted on the water inlet to buffer and store air in the apparatus. This method includes actuating a motor for imparting the pulsation and suction motion; and supplying material onto the jigging bed.

In another embodiment, the fluid can be media or water. In yet another embodiment, the fluid can be air-free.

While the invention has been described and shown with particular reference to the preferred embodiment, it will be apparent that variations might be possible that would fall within the scope of this application.

### BRIEF DESCRIPTION OF THE DRAWINGS

FIG. 1 illustrates a schematic view of one embodiment of the jig concentrator;

FIG. 2A illustrates a perspective view of an exemplary pulsation valve used with the embodiment in FIG. 1;

FIG. 2B illustrates a perspective view of another exemplary pulsation valve used with the embodiment in FIG. 1;

FIG. 3 illustrates a schematic view of the jigging bed and water assembly;

FIG. 4 illustrates is a bottom view of the jig showing slots in the pipes located below the jig-bed, e.g., the fluid delivery via pipes system or assembly

FIG. 5 illustrates a schematic view of the jig hutch; and

FIGS. 6A, 6B, and 6C show illustrative examples of pulsation values.

### DETAILED DESCRIPTION

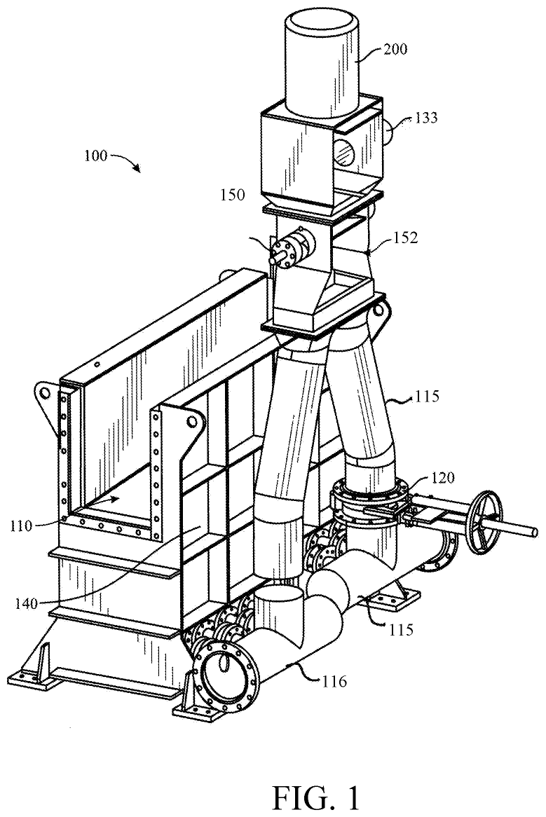

FIG. 1 shows one embodiment of the jig or jig concentrator 100 in which the jig concentrator 100 includes a jigging bed 110 having one or more holes, a flow control valve 120 associated with the jigging bed 110 to control a flow of fluid into through the jigging bed 110, a pulsation or pulsation valve 150 connected to the flow control valve for controlling a pulsation of fluid inlet 133 operatively connected to the water pulsation valve 150 for input of water jig concentrator 100; and a pressured air buffer or expansion tank 200 mounted on the water inlet to buffer and store air or water in the apparatus. The jigging bed 110 can be a typical jigging bed known in the art, e.g., for density separation. Water headers 116 can be seen, which are offset and capped.

Beneath of jigging bed 110 may be a single or multiple fluid or liquid distribution assembly (shown later), each containing a single or multiple opening/slots for the release of a fluid. These fluids can be water or media with a specific gravity. A jigging bed 110 of the jig concentrator 100 holds the materials, which can be stratified and layered into heavy and light particles. The jigging bed 110 used to support the layered heavy and light particles identified by differences in specific gravity. The jigging bed 110 anticipates a material support that allows the fluid to be pulsed through it from the water or media pulsed from the pipes 115 (also shown later). The jigging bed 110 can use a screen media, e.g., a punched screen plate to support the light and heavy particles, which are known in the art.

As can be seen, the jig concentrator 100 has a hutch or frame 140, a jigging bed 110 in the hutch 140. The jigging bed 110 or supports allows the water to flow through the holes (shown later) in the jigging bed 110 to create pulsation and suction stroke motion and a flow control valve 120 associated with the jigging bed to control a flow of fluid. The flow control valve 120 restricts the flow per unit of time to establish the amplitude of the jigging stroke. The water pulsation valve 150 connected to the valve housing 152 controls the pulsation of water and for determining the frequency and (amplitude) of the jigging stroke. The water inlet 133 attached to the water pulsation valve 120 for input of water or media in the jig concentrator. A pressured air buffer or expansion chamber 200 mounted on the water inlet to buffer and store air can be used to allow for adequate pulsation. In this embodiment, the pulsing is created with water flow or media flow without the need for air or other mechanical devices.

The jigging bed 110 may be used for supporting a ragging material. The punched screen plate is a standard that may offer sufficient open area, to support an accurately sized material used as ragging material or material. The ragging material, that attempts to pass the openings of the jigging bed may not, is retained on the jigging bed.

The jigging bed 110 supports material to react to the principle of jigging. The jigging is actuated by alternate strokes of pulsation and suction (or flow and no flow). The material supported by the jigging bed 110 begins to dilate at start of a pulsation stroke, and separation of particles through differential acceleration followed by free settling and hindered settling principles. A suction stroke can help stratification of the material bed according to the specific gravity and consolidation trickling of fine particles.

One or more flow control valves 120 is associated with the jigging bed 110. The flow control valve 120 regulates the flow of the fluid to influence the amplitude of the jigging stroke. The flow control valves 120 may be fitted with actuators and position holders. Pneumatically-actuated globe valves and diaphragm valves are widely used for control purposes in many industries, although quarter-turn types like ball and butterfly valves are also used. The flow control valves 120 can also work with hydraulic actuators and may be known as hydraulic pilots. These types of valves are also known as automatic control valves. The flow control valves may also be manual. The hydraulic actuators respond to changes of pressure or flow and will open/close the valve. Automatic control valves do not require an external power source, meaning that the fluid pressure is enough to open and close them.

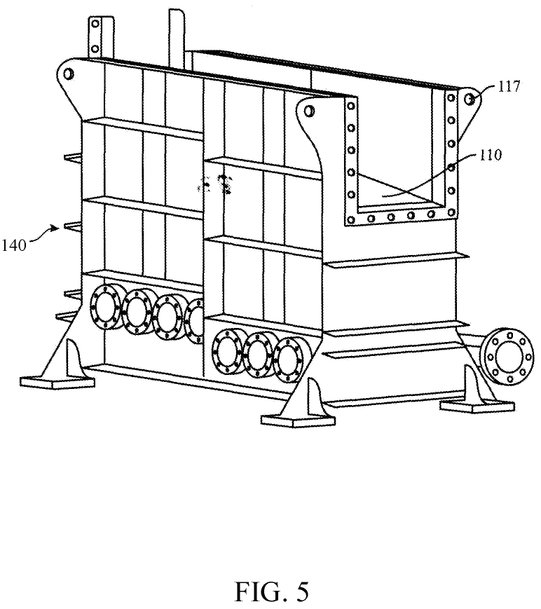

Referring to FIG. 5, multiple hutches 140 can be connected to form a jigging bed 110 for storing of the fluid and may be a conduit for the discharge of material. The hutch 140 openings may or may not be fitted with valves. The frames can be connected through, e.g., bolt holes 117, to elongate the frame or bed. The jig concentrator apparatus 100 and the fluid reservoir are all contained within a vessel and the hutch 140 is filled with fluid. The hutch 140 can be a single unit or chamber or be multiple units or chambers. The chambers included to collect any material that finds its way below the hutch 140. Integrated into the jig concentrator apparatus 100, there may be a mechanism for separating feed material that has experienced jigging action and rising current action. The jigging bed 110 has holes like those skilled in the art.

A water pulsation valve 150 can be in fluid connection with the flow control valve 120 for controlling a pulsation and flow of water. The water pulsation valve 150 regulates the frequency of the flow of fluid, generally water or media, to create the jigging stroke from a reservoir of pressured fluid generated by a centrifugal, reciprocating or peristaltic positive displacement pump, and regulates the acceleration and decelerations of the fluid that is pumped. This uncontrolled energy appears as pressure spikes and usually leads to damaged seals, gauges, diaphragms, valves and piping joints. To avoid such damage an air reservoir or expansion tank 110 can be included in the piping of the jig concentrator apparatus 100.

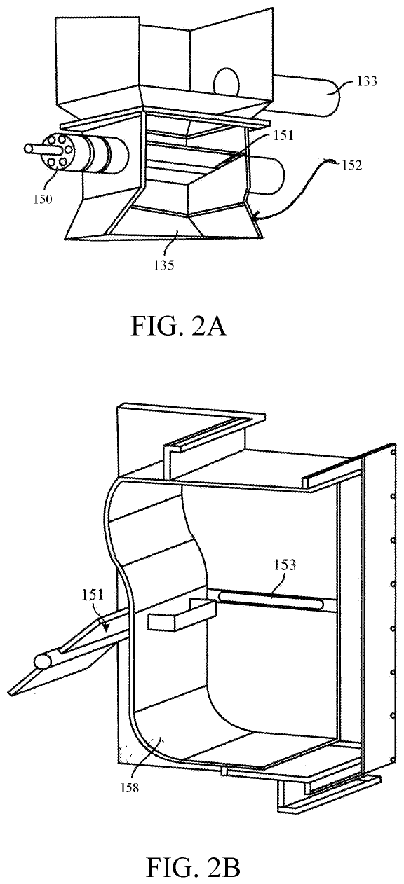

FIG. 2A and FIG. 2B show an exemplary pulsation valve 150 is housed under the water inlet 133 to control, and if needed, by-pass a portion of the fluid. Water inlet 133 allows water to flow therein, and water exits through exit opening 135 of the value housing 152. FIG. 2B show half of the valve and its mirror image is opposite to the adjustable housing 152. The pulsation valve 150 may also be referred to as a dynamic, severe flow control valve 150.

As can be seen from FIG. 2A and FIG. 2B, the pulsation valve 150 can have an adjustable housing or diaphragm 158 to allow for controlled by-pass of the fluid and the fluid inlet (not shown) is on the top portion to let water or media therein. In one example the adjustable housing can slide along slide 153. As shown in a propeller 151 is attached to the adjustable housing for generating a disturbance in fluid flow, from (that) the severe disturbance of flow from minimal to full flow a jigging stroke is created within the jig hutch, which causes the particles moves in a jigging motion. The adjustable housing 152 may move in the horizontal direction from the flow of fluid to allow more or less fluid to by-pass the pulsation valve. The pulsation valve 150 can control the flow of water through a flexible hose by clearance with the housing to allow for flows containing solid particulate matter such as slurries. The valve body or housing or diaphragm 158 may be constructed from plastic, metal, or other materials depending on the intended use.

The jig concentrator pulses the water upwards from the lower portion of the hutch 140. The water from beneath creates a vertical pulsation of water or rising current, that is evenly distributed throughout the hutch 140 of the jig concentrator. This type of water motion provides advantages in particle stratification and economics. The water is controlled through the flow control valve 120 and flow in direction of the hutch 140. A jigging stroke maintained by a reservoir of relatively high-pressure fluid from that pulsating delivery allows a release of a predetermined volume of fluid. The stroke may be a sinusoidal wave or a skewed sinusoidal wave.

The fluid reservoirs and pipes under the jigging bed 110. In this arrangement, there is delivery of relatively equal amounts of fluid (water or media) from each outlet on the fluid reservoir. In this arrangement, the widths of jigging concentrators are no longer limited by the projection of a pressure wave such as is created by pulsed air forcing the movement of water. The intermittent and timed delivery of water under pressure into the jig hutch 140 occurs independent of air pulsations or mechanical devices that constrict the volume of fluid inside the jig hutch 140.

A water inlet 133 attached in fluid connection with to the water pulsation 150 valve for input of water in the apparatus 100. The water inlet 133 may fill the apparatus with water at a predetermined pressure. The width of jigging bed 110 may much wider. The water is flowing from inlet.

FIG. 4 shows a bottom view of the jigging bed 110 hutch 140, which can have one or multiple slots 180 associated with delivery pipes 185 for separating the material from the material. The slots 180 keep the original strength of the delivery pipe 185 and provide more uniform distribution of fluid. The slots on the bottom can be used to avoid buildup of particles where the water is dirty or the media is thicker. There may be one or multiple slots 180 in the delivery pipes 185.

Referring to FIG. 4, multiple fluid inlet 165 to conserve the fluid in the apparatus 100. The pulsating action of the fluid may projected within reasonable geometric limitations. The pulsating source may be limited by the volume of the reservoir. multiple fluid inlet 165 to conserve the fluid in the apparatus 100. The pulsating action of the fluid may project without reasonable geometric limitations. The pulsating source may be limited by the volume of the reservoir. The fluid inlets are connected to water headers 116.

The jigging concentrator may have a 40′ wide jigging bed with an even jigging stroke across the full width. Specifically, the jig of increased effectiveness by reason of the use of more efficient jigging stroke made so by the fluid introduction into the hutch 140 with relatively independent control of the amplitude, frequency and acceleration of the stroke.

A pressured air buffer 200 mounted on the water inlet 133 to buffer and store air in the apparatus 100. The pressured air buffer 200 can act as a buffer and a variable storage medium for the water inlet 133. The pressured air buffer 200 will modulate its capacity during normal work, as water is consumed and replenished in the water reservoir 116.

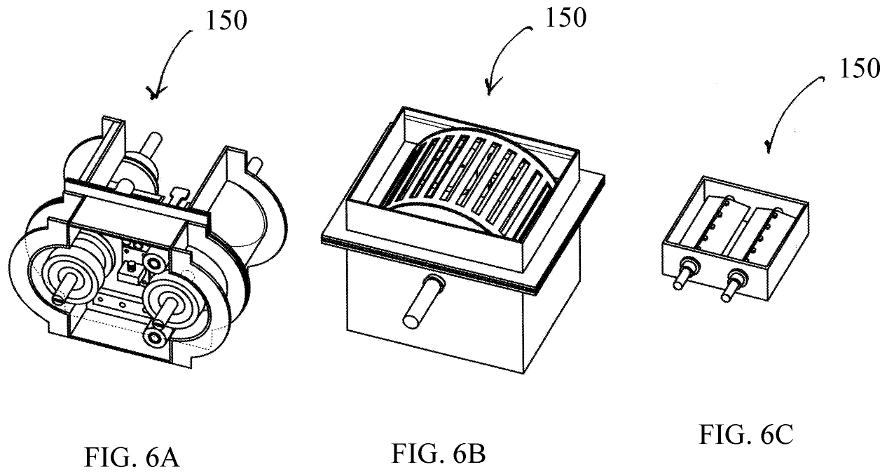

As shown herein and for example in FIGS. 6a, 6b, and 6c, there can be multiple types of pulsation valves 150 known and developed in the future.

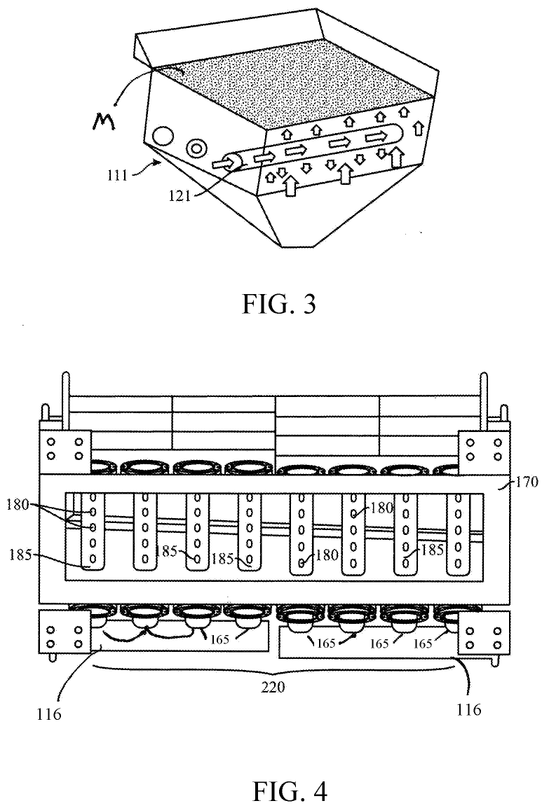

Referring to FIG. 3, a schematic drawing, the jigging concentrator 100 provides an optimal jigging stroke with a pulsating rising current. The ideal jigging stroke is based on the specific gravity. The specific gravity also known as gravity separation. The gravity separation uses density of particles in fluid. Pulsating water with controlled alternating pressure enters in the apparatus, through the water inlet 133 the water enters in the jig. The water that entered in jig is slurry. The slurry may separate the heavy and light particles from the gravity separation. The water rises on the jig bed through a screen called perforated plates that made from a urethane. Material M can be separated.

Multiple hoppers can be connected to the hutch 140 for collecting any heavy and light particles discharged below the material support device. The hopper is a large, pyramidal shaped container used in processes to hold particulate material that has collected from expelled fluid, discharged through the material support device or discharged by mechanisms installed to separate high density particles from lower density particles. The hoppers are usually installed in groups to allow for a greater collection quantity. The hopper walls are insulated to protect the outside environment and personnel from the discarded contents.

In operation and use or as schematically shown in FIG. 3, water or media to the jig concentrator 100 (section thereof) pulses upwards from beneath the hutch or jigging bed 140 through one or more pipes with holes or slots. The water from beneath creates a vertical pulsation of water or rising current, which is releases along the walls of the hutch of the jig concentrator. This type of water motion provides advantages in particle stratification and economics of material M. Water or media can be controlled through a typically flow valve and can flow along the direction of the arrowed line in the hutch or bed. This embodiment can achieve a jigging stoke by maintaining a reservoir of relatively high-pressure fluid, primarily water, from which a pulsating delivery system allows the release of a predetermined volume of fluid or through the use of a pulsating pump. The resulting action on particles located on a jigging bed is the same. The pulsation or pulsation can be created by media, water, or air free fluid.

FIG. 4 shows a bottom view of the jigging bed 140 of jig concentrator 100 on frame 170, which can have multiple slots 180 associated with delivery pipes 185 for separating the material from the material. The slots 180 keep the original strength of the delivery pipe 185 and provide more uniform distribution of fluid. The slots on the bottom can be used to avoid buildup of particles where the water is dirty or the media is thicker. The slots 180 also separate the heavy particles that may be entrained with the jigging fluid (e.g., media or water).

Another embodiment includes a method of sizing and separating particles of a generally low-density material, using a jig concentrator comprising a stand, a frame, a jigging bed in the frame on the stand. The jigging bed supports allows the water to flow through the holes in the jig bed to create pulsation and suction stroke motion, a flow control valve 120 associated with the jigging bed to control a flow of fluid, wherein the flow control valve 120 restricts the flow per unit of time to establish the amplitude of the jigging stroke; a water pulsation valve connected to the flow control valve 120 for controlling a pulsation of water and for determining the frequency of the jigging stroke, and a water inlet attached to the water pulsation valve for input of water in the apparatus; and a pressured air buffer mounted on the water inlet to buffer and store air in the apparatus. The steps include actuating a motor for imparting the pulsation and suction motion; and supplying material onto the jigging bed.

Another embodiment includes a jig that powered by a motion and gears like other jigs on the market and known to those with skill in the art. Methods and systems can include actuating a motor for imparting the pulsation and suction motion; and supplying material onto the jigging bed.

One embodiment includes a jig that is not a Baum Jig and does not use air to set water into a jigging stroke motion. It such embodiments, certain do not include diaphragms or mechanical levers or plungers to set water into a jigging stroke motion. These embodiments allow a pulsation valve to control the flow of only water to create a jigging stroke motion. In so doing the design can create an even jigging stroke over a width of jigging machine that can result in a wider jigging bed than those of typical baum or mechanical jigs.

The light and heavy particles are separated by the jig concentrator 100 without consuming long hours. Moreover, the metal is separated from material stream. The effectiveness of the jigging in the bed of liquid can be varied accordingly. The valves and liquid flow so that the forces in the jigging bed 140 are effective.

As can be seen, the terms “heavier” and “lighter” refer to relatively greater and lesser specific gravity, respectively. Within the separation, absolute weight can be less important than buoyancy in the fluid.

Although the field of the invention has been described herein with limited reference to specific embodiments, this description is not meant to be construed in a limiting sense. Various modifications of the disclosed embodiments, as well as alternate embodiments of the invention, will become apparent to persons skilled in the art upon reference to the description of the invention.

1. A jig concentrator, comprising;
a jigging bed having a plurality of holes;
a flow control valve associated with the jigging bed to control a flow of fluid;
a pulsation valve connected to the flow control valve for controlling a pulsation of water or media, wherein the valve is housed under the bed;
a water or fluid inlet attached to the water pulsation valve for input of water in the jig concentrator; and
a pressured air buffer mounted on the water inlet to buffer and store air in the jig concentrator.

2. The jig concentrator of claim 1, wherein the jigging bed supports allows the water to flow through the holes in the jig bed to create pulsation and suction stroke motion, a flow control valve associated with the jigging bed to control a flow of fluid, wherein the flow control valve restricts the flow per unit of time to establish the amplitude of the jigging stroke; a water pulsation valve connected to the flow control valve for controlling a pulsation of water and for determining the frequency of the jigging stroke, and a water inlet attached to the water pulsation valve for input of water in the apparatus.

3. The jig concentrator of claim 1, wherein a pulsation valve is housed under the fluid inlet to independently control by-pass of the fluid.

4. The jig concentrator of claim 1, further comprising pipes with holes to create even distribution of fluid through jigging bed in the jig concentrator.

5. The jig concentrator of claim 1, wherein a punched screen plate is connected to the jigging bed for supporting a ragging material.

6. The jig concentrator of claim 2, wherein a plurality of delivery pipes are attached to the hutch for input of the fluid in the jig.

7. The jig concentrator of claim 2, wherein multiple chambers are connected to the hutch for collecting any heavy and light particles.

8. The jig concentrator of claim 2, wherein plurality of slots associated with delivery pipes for the even delivery of jigging fluid for optimizing the stratification of the material the in layers based on density.

9. A method of sizing and separating particles of a generally low-density material, using a jig concentrator comprising a stand, a frame, a jigging bed in the frame on the stand, wherein the jigging bed supports allows the water to flow through the holes in the jig bed to create pulsation and suction stroke motion, a flow control valve associated with the jigging bed to control a flow of fluid, wherein the flow control valve restricts the flow per unit of time to establish the amplitude of the jigging stroke; a water pulsation valve connected to the flow control valve for controlling a pulsation of water and for determining the frequency of the jigging stroke, and a water inlet attached to the water pulsation valve for input of water in the apparatus; and a pressured air buffer mounted on the water inlet to buffer and store air in the apparatus, comprising:
a) actuating a motor for imparting the pulsation and suction motion; and
b) supplying material onto the jigging bed.

10. The method of claim 9, wherein the pulsation valve is housed under the bed to control by-pass of the fluid.

11. The method of claim 9, wherein the fluid is media or water.

12. The method of claim 9, wherein the fluid is air free.
